(19) United States
(12) Patent Application Publication
(10) Pub. No.: US 2009/0195257 A1
(43) Pub. Date: Aug. 6, 2009

(54) Method and device for monitoring a first voltage value

(76) Inventor: Winfried Hasenberg, Koeln (DE)

Correspondence Address: KENYON & KENYON LLP, ONE BROADWAY, NEW YORK, NY, 10004, US

(21) Appl. No.: 11/988,469

(22) PCT Filed: Aug. 1, 2006
(86) PCT No.: PCT/EP2006/064884

§ 371 Date: Jan. 15, 2009

(30) Foreign Application Priority Data
Aug. 1, 2005 (DE) 10 2005 036 047.5

(51) Int. Cl. H01H 31/02; B60L 1/00

(52) U.S. Cl. 324/555; 307/10.1

(57) ABSTRACT

A method for monitoring a first voltage value of a signal voltage that resides within a signal voltage range, is outputtable by an electronic component, and is recordable by a measuring device having an input voltage range that is smaller than the signal voltage range, a voltage divider transforming the signal voltage range into the input voltage range, a first voltage value being initially measured by the measuring device, a component having an electrical resistance being at least partially connected in parallel to the voltage divider; a second voltage value being subsequently measured by the measuring device, and the result of the monitoring being derived from the comparison of the first and second voltage values. In addition, a device having a voltage divider, switch means and a component having an electrical resistance, the component having an electrical resistance being connectable at least partially in parallel via the switch to the voltage divider.

### FIELD OF THE INVENTION

The present invention relates to a method and a device for monitoring a first voltage value.

### BACKGROUND INFORMATION

In the following, although reference is made primarily to automobile manufacturing, the present invention is not limited to this application.

Nowadays, microcontrollers (μC), which have an analog-digital converter (ADC), typically a multi-channel analog-digital converter having a reference voltage of 5 V, are being used to an increasing degree within electrical or electronic components or, generally, in circuits (for example, motor controllers). The purpose of these analog-digital converters is to receive analog voltages from sensors in a motor vehicle, for example, and to convert the same into digital signals, which are then processed further.

For that reason, the sensors are typically designed for a supply voltage of 5 V. The analog output signal or sensor signal then encompasses a valid measuring range of 0.5-4.5 V, for example. When the voltage measured by the analog-digital converter is in the low range, for example below 0.25 V, or in the upper range, for example above 4.75 V, then this is indicative of an error (idle condition, short circuit, ground interruption, etc.).

At the same time, integrated circuits, such as the mentioned microcontrollers, which require a supply voltage of only 3.3 V, are being used to an increasing degree. The Infineon TriCore TC1766 microcontroller used in the automotive industry is an example. As a result, only a 3.3 V reference voltage is still available for the internal analog-digital converters, i.e., a reliable conversion is only still possible within the range from 0 V to 3.3 V.

It has been shown that this change does not lead to any degradation of the diagnostic function of the passive sensor system (for example, NTCs (negative temperature coefficient resistors), accelerator potentiometers, etc.) when the sensor supply voltage is likewise changed over to 3.3 V. In addition, active analog sensors (for example pressure sensors) are also used, however. The reference and supply voltage of these sensors is inherent to the manufacturing process. Active 3.3 V sensors are only offered by few manufacturers and at high prices. Therefore, it is not desirable to use these sensors.

Conventional approaches for operating active 5 V sensors include using a 3.3 V analog-digital converter. German Patent Application DE 100 50 962 Al describes a method whereby five reference signals are used to determine a first signal as precisely as possible. This method requires a complicated and expensive design in terms of circuit engineering.

The German Patent Application DE 102 32 361 Al describes a method for ascertaining a signal voltage where the signal voltage is determined by periodically measuring the signal potential and subsequently comparing the same and a supply potential in each instance with a ground potential. Many individual method steps are involved in implementing this method.

In principle, it is possible, for example, for the output signal to be adapted via a precision voltage divider to the measuring range of the 3.3 V analog-digital converters. The accuracy of the measured-value acquisition suffices in many cases. However, a complete diagnostic functionality of a sensor according to the OBD-II standard is no longer given when a precision voltage divider is used. To signal an interruption of the sensor ground, active sensors typically have an internal pull-up resistor, whose functionality is clarified further below with reference to FIG. 1a.

In the case of an interrupted sensor ground, a sensor signal of approximately 5 V is present at the output of the sensor. This constitutes an implausible voltage value. A 1C connected to the sensor and having an integrated 5 V analog-digital converter can recognize this error and evaluate the same via software. However, if the sensor is connected via a voltage divider to a μC having an integrated 3.3-V analog-digital converter, in response to interruption of the sensor ground via the internal pull-up resistor of the sensor, as well as via the resistors of the voltage divider, a voltage results at the analog-digital converter input that is within the plausible signal range and, therefore, cannot be evaluated by the software. The error is not recognized, and a diagnosis is not possible.

To circumvent this problem, conventional methods provide for using an additional 5 V analog-digital converter, for example a CY100, which is connected via a digital interface, for example SPI bus, to the μC. The inherent disadvantage of this approach is, in particular, that it entails additional costs for the 5 V analog-digital converter module. For the most part, not all of the channels of the multichannel analog-digital converter modules are used, which also constitutes a waste of resources. In motor vehicle manufacturing, because of the SPI bus (approx. 1 ms time base), the use of CY100 in motor controllers limits the readout rate for the analog-digital converter values, so that this module cannot be used for safety-critical functions (such as common-rail pressure). In addition, the module places demands on the SPI resources.

### SUMMARY

An object of the present invention to devise a method and a device which will make it possible to improve the operation of components having an output voltage at components having an input voltage which differs from the output voltage.

In an example method according to the present invention for monitoring a first voltage value of a signal voltage that resides within a signal voltage range, is outputtable by an electronic component, and is recordable by a measuring device having an input voltage range that is smaller than the signal voltage range, a voltage divider transforming the signal voltage range into the input voltage range, a first voltage value is initially measured by the measuring device, a component having an electrical resistance is at least partially connected in parallel to the voltage divider, and, subsequently thereto, a second voltage value is measured by the measuring device. The monitoring result is derivable from the comparison of the first and second voltage values.

An error of the electronic component is advantageously recognized when the first voltage value differs from the second voltage value by at least one predefined threshold value.

The present invention may, in particular, be implemented by a series connection of a component having a resistor (resistor-type component) and a switch (for example, MOSFET), which are connected in parallel to a (precision) voltage divider. The switch, respectively the semiconductor, is preferably controlled by the measuring device (for example, μC). In particular, when the read-in first voltage value resides within a voltage range within which it is not uniquely identifiable as a valid or erroneous value, the resistor-type component is connected at least partially in parallel to the voltage divider before a subsequent measurement of a second voltage value is taken, preferably by the measuring device.

The first voltage value may now be verified or monitored by comparing the first and the second voltage values. If, for example, the first voltage value is a valid voltage value, then the second voltage value will only differ insignificantly. On the other hand, in the case of an error, i.e., a ground interruption, then the electronic component, together with the parallel circuit composed of the voltage divider and the resistor-type component, forms a new voltage divider. As a result, a measurable change in voltage ensues. An error is able to be uniquely identified.

In the case of the method according to the present invention, it is advantageous when an effective resistance of the voltage divider and of the component, which is at least partially connected in parallel and which has an electrical resistor, is substantially smaller than an internal electrical resistance of the electronic component. This allows a readily detectable change in voltage to result in the case of an error.

In one preferred specific embodiment of the method according to the present invention, the electronic component is designed as a sensor, in particular in a motor vehicle.

In another preferred specific embodiment of the method according to the present invention, the measuring device is designed as an analog-digital converter, in particular one that is integrated in a microcontroller. The TC1766 mentioned above is cited as an example. It is understood that the measuring device may also be designed as an external analog-digital converter.

In the example method according to the present invention, it is expedient when the signal voltage range is designed for operation from 0 V to 5 V. This advantageously makes the method applicable to the mentioned 5 V components used in electronics.

It is also advantageous when, in the case of the example method according to the present invention, the input voltage range is essentially designed for operation from 0 V to 3.3 V. This advantageously makes the example method applicable to the mentioned 3.3 V components used in electronics.

In the case of the example method according to the present invention, it is advantageous when the component having an electrical resistance is designed as an ohmic resistor. An ohmic resistor is a simple, inexpensive and easily manipulable component that is especially rugged and reliable.

The example method according to the present invention may be used quite advantageously to determine a ground interruption.

It is especially preferred for a method in accordance with an example embodiment of the present invention to be used in the automobile manufacturing sector.

In accordance with an example embodiment of the present invention, a device is provided having a voltage divider, a switch and a component having an electrical resistor, the component having an electrical resistance being connectable at least partially in parallel via switch (121), to voltage divider (110, 111, 112).

In one preferred embodiment, the example device according to the present invention has a comparator for comparing a first and a second voltage value. In this context, it may, in particular, be a question of a microcontroller, as mentioned.

The example device according to the present invention advantageously also may have features which correspond to preferred specific embodiments of the method according to the present invention.

It is preferred when the example device according to the present invention is suited for implementing the example method according to the present invention.

In one preferred specific embodiment, the device according to the present invention is provided in a motor vehicle.

A motor vehicle according to the present invention is equipped with a device according to the present invention.

The advantages of the mentioned preferred specific embodiments of the method according to the present invention and of the device according to the present invention are described comprehensively in the following. They apply correspondingly to each specific embodiment.

The related-art disadvantages encountered during operation of active 5 V sensors at 3.3 V analog-digital converter inputs of present-day microcontrollers, for example, are overcome by the measures of the present invention. The method according to the present invention eliminates the need for external 5 V analog-digital converter modules, which results in a cost saving.

In addition, the present invention makes it possible for active 5 V sensors to be operated at full diagnostic capacity on microcontrollers having 3.3 V analog-digital converter inputs. In other words, even errors which are not detectable under the related art, such as the interruption of the sensor ground, for example, are detected.

The described approach may be implemented using a few low-cost components. The OBD II standard is advantageously met. The approach in accordance with the present invention advantageously has no appreciable effect on the accuracy of a voltage value measurement.

A microcontroller is able to read in voltage values from active sensors, in particular those relevant to safety (such as pressure sensors in airbags) more rapidly than is possible, for example, via the conventional SPI interface of the CY100. The resources of the microcontroller are used effectively.

It is understood that the aforementioned features and those which are still to be explained in the following may be utilized not only in the particular stated combination, but also in other combinations or alone, without departing from the spirit and scope of the present invention.

The present invention is schematically illustrated in the figures based on an exemplary embodiment and is described in detail in the following with reference to the figures.

### BRIEF DESCRIPTION OF THE DRAWINGS

FIG. 1a shows a schematic representation of a conventional device.

FIG. 1b shows a schematic illustration of one preferred specific embodiment of a device according to the present invention.

FIG. 2 depicts a flow chart of a preferred embodiment of the method according to the present invention.

### DETAILED DESCRIPTION OF EXAMPLE EMBODIMENTS

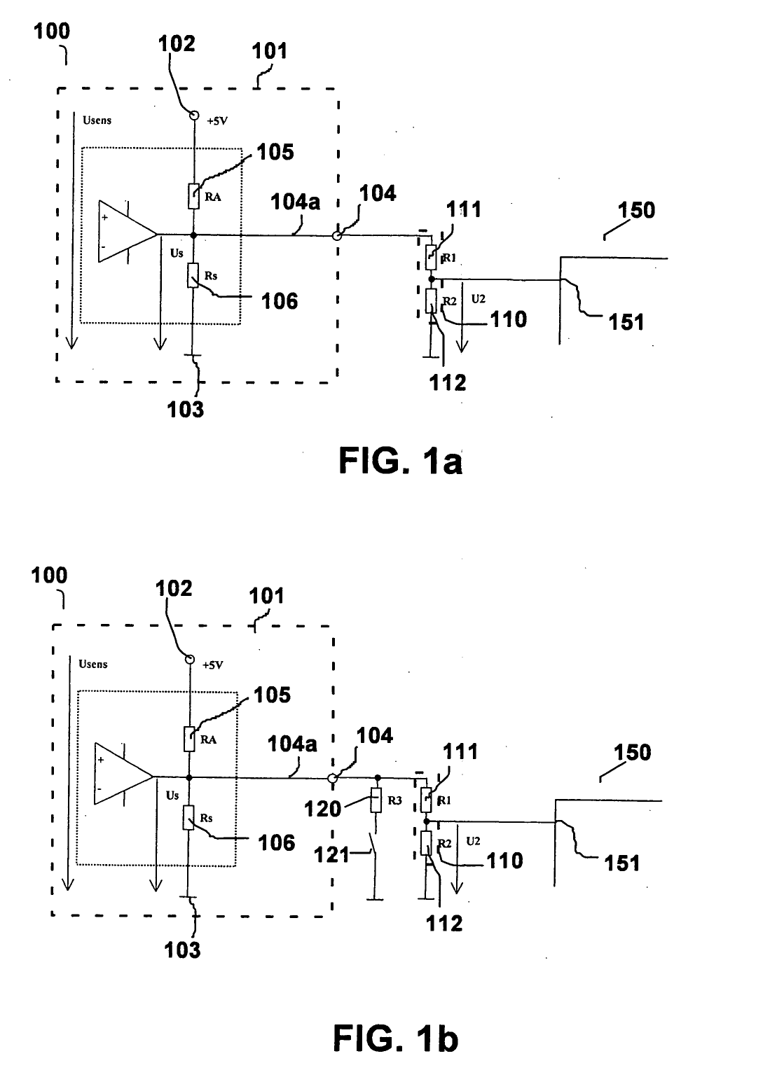

FIG. 1 shows, in a conventional system, the connection of a sensor 100 to a microcontroller 150 in a motor vehicle. Sensor 100 has a housing 101 which is schematically indicated by the broken line. In addition, sensor 100 has a connection 102 for the supply voltage; in the illustrated case, for +5 volt, and a connection 103 for ground. Therefore, the voltage range from 0 V to 5 V, which is represented by an arrow denoted as Usens, is available for a sensor voltage or output voltage Us. The potential of output voltage Us is represented by the arrow denoted as Us.

Sensor 100 has an output 104 where sensor signal Us is supplied. The sensor is implemented in a so-called pull-up-down circuit. In this circuit, the signal line is connected via resistors to the supply voltage and to ground. In the illustration shown, a signal line 104a is connected via a pull-up resistor 105 to the supply voltage 5 V and via a pull-down resistor 106 to ground 0 V. One skilled in the art is quite familiar with the operating principle and function of a circuit of this kind, so it will not be discussed in further detail here.

During operation, a sensor voltage within the range of between approximately 0.5 V and 4.5 V is present at output 104 of sensor 100. Microcontroller 150 has an input 151. In this example, the microcontroller has an input voltage range from 0 V to approximately 3.3 V. For this reason, conventional systems provide for using a voltage divider 110 to adapt sensor voltage Us output by sensor 100 at output 104 to the input voltage range of microcontroller 150. Voltage divider 110 has two resistors 111 and 112, which have a value of R1 and R2, respectively. Since microcontroller 150 has a relatively high input resistance at its analog-digital converter input 151, in the present case, the forms for the unloaded voltage divider may be used. Therefore, input voltage U2 at analog-digital converter input 151 of microcontroller 150 is calculated as:

U2=Us*R2/(R1+R2)

If a sensor malfunction occurs, for example due to an interrupted sensor ground at connection 103, sensor 100 loses its functionality. It then supplies output voltage +5 V at output 104. In this case, a voltage U2, expressed as

U2=5 V*R2/(RA+R1+R2)

is present at analog-digital converter input 151 of microcontroller 150:

Therefore, U2 is lower than 3.3 V, which is why microcontroller 150 is not able to detect an error.

It will now be shown with reference to FIG. 1b, how this disadvantage is overcome by the measure according to an example embodiment of the present invention.

In FIG. 1b, the schematic representation from FIG. 1a is shown together with a resistor 120 and a switch 121. Resistor 120 is connected in series to switch 121. In addition, resistor 120 is connected to output signal line 104a. Moreover, switch 121 is connected to ground. In the illustrated open position of switch 121, there are no changes in the performance characteristics explained with reference to FIG. 1a.

The illustrated circuit arrangement reveals a complete parallel connection of resistor 120 to voltage divider 110. In accordance with the present invention, a partial parallel connection would already suffice. In the illustrated example, this would be understood, in particular, as resistor 120 being connected in parallel only to resistor 111 or to resistor 112.

If microcontroller 150 detects a voltage value UT close to 3.3 V at analog-digital converter input 151, then it is not able to ascertain with certainty that an error exists. As already explained, in this context, it may be a question of a regular output value of sensor 100 or of the output value of a defective sensor. At this point, microcontroller 150 actuates switch 121, so that signal line 104a is connected via resistor 120 and switch 121 to ground. In addition, a parallel connection of resistor 120 to voltage divider 110 is formed. Two cases may now be differentiated.

If it is a question of a regular output value of the sensor, then there will be no significant change in voltage U2, since a functioning sensor output is typically indicative of an active voltage source. The change in voltage will turn out to be all the smaller, the smaller the internal resistance of this voltage source is in comparison to the total resistance of parallel-connected resistors R1+R2 and R3.

In the exemplary error case, i.e., in the case of an interruption of the sensor ground, resistors 105, 111, 112 and 120 make up an effective voltage divider system. For that reason, voltage U2 dropping across resistor 112 is measurably lower than 3.3 V. This change in voltage prompts microcontroller 150 to recognize a defective sensor and to respond accordingly.

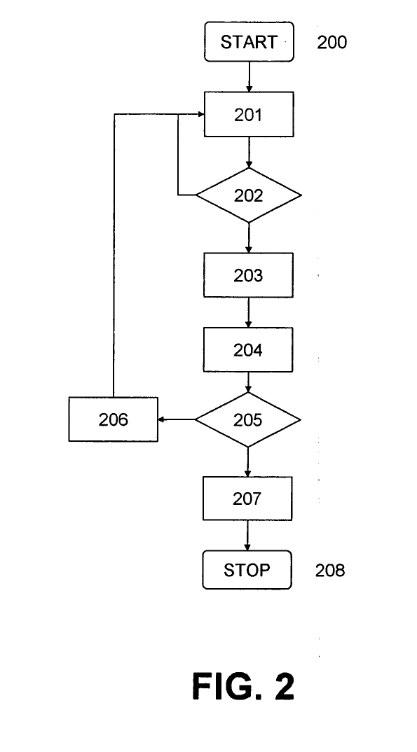

FIG. 2 shows a preferred specific embodiment of the method according to the present invention as a flow chart. The procedure starts in a step 200. In a step 201, a first voltage value is measured by the measuring device, for example an analog-digital converter, which is integrated in a microcontroller. In a step 202, the microcontroller checks whether the measured first voltage value resides within a voltage range that does not allow a precise error determination. For example, if a 5 V sensor is operated on a 3.3 V analog-digital converter in the form explained above, one approach provides, for example, for using a voltage threshold value of approximately 3 V. If the measured first voltage value is above 3 V, it is not possible to definitively state whether it is a question of a regular measured value or of the readout of a faulty sensor.

If the measured first voltage value is below this predefinable voltage threshold value, then the procedure continues with method step 201. In this case, it is a question of regular operation.

If, in step 202, the measuring device recognizes a first voltage value which is above the predefinable voltage threshold value, the procedure branches to a method step 203.

In step 203, a component having an electrical resistance, in particular an ohmic resistor, is connected in parallel to the voltage divider. In a subsequent step 204, a second voltage value is measured by the measuring device.

The first and the second voltage values are compared in a method step 205. If there is no measurable difference between the first and the second voltage values, the parallel connection of the resistor component and the voltage divider is ended in a method step 206 and the procedure returns to method step 201. It is then a question of a regular measured value.

If a measurable difference between the first and the second voltage values is recognized in method step 205, this is an indication to the measuring device that it is a question of an irregular voltage value and thus that the corresponding sensor is defective. The procedure subsequently branches to a method step 207.

In method step 207, the defect of the sensor, for example of a central control device (not shown) is signaled. Other responses are possible, including recording in a log internal to the vehicle, notifying the driver, for example, by light or sound signal, etc. The procedure then ends in a step 208.

The described specific example embodiments of the device according to the present invention and of the method according to the present invention make it possible to improve the operation of components having an output voltage at components having an input voltage which differs from the output voltage.

1-15. (canceled)

16. A method for monitoring a first voltage value of a signal voltage that resides within a signal voltage range, is outputtable by an electronic component, and is recordable by a measuring device having an input voltage range that is smaller than the signal voltage range, a voltage divider transforming the signal voltage range into the input voltage range, the method comprising:
initially measuring a first voltage value using the measuring device, a component having an electrical resistance being at least partially connected in parallel to the voltage divider;
subsequently measuring a second voltage value using the measuring device; and
monitoring by comparing the first voltage value and second voltage value.

17. The method as recited in claim 16, further comprising:
recognizing an error of the electronic component when the first voltage value differs from the second voltage value by at least one predefined threshold value.

18. The method as recited in claim 16 wherein an effective resistance of the voltage divider and of the component, which is at least partially connected in parallel and which has an electrical resistance, is substantially smaller than an internal electrical resistance of the electronic component.

19. The method as recited in claim 16, wherein the electronic component is a sensor.

20. The method as recited in claim 16, wherein the measuring device is an analog-digital converter integrated in a microcontroller.

21. The method as recited in claim 16, wherein the signal voltage range is 0 V to 5 V.

22. The method as recited in claim 16, wherein the input voltage range is 0 V to 3.3 V.

23. The method as recited in claim 16, wherein the component having an electrical resistance is an ohmic resistor.

24. The method as recited in claim 16, further comprising:
determining a ground interruption of the electronic component using the comparison.

25. The method as recited in claim 16, wherein the method is used in the automobile manufacturing sector.

26. A device comprising:
a voltage divider;
a switch; and
a component having an electrical resistance;
wherein the component having an electrical resistance is connectable at least partially in parallel via the switch to the voltage divider.

27. The device as recited in claim 26, further comprising:
a comparator adapted to compare a first voltage value and a second voltage value.

28. The device as recited in claim 27, wherein the device recognizes an error of an electronic component based on a comparison by the components.

29. The device as recited in claim 27, wherein the device is provided in a motor vehicle.

30. A motor vehicle having a device comprising:
a voltage divider;
a switch; and
a component having an electrical resistance;
wherein the component having an electrical resistance is connectable at least partially in parallel via the switch to the voltage divider.
